(19) United States
(12) Patent Application Publication
(10) Pub. No.: US 2016/0338814 A1
(43) Pub. Date: Nov. 24, 2016

(54) Plasma toothbrush

(71) Applicant: Kwangwoon University Industry-Academic Collaboration Foundation, Seoul (KR)

(72) Inventors: Guangsup Cho, Seoul (KR); Yunjung Kim, Seoul (KR)

(73) Assignee: Kwangwoon University Industry-Academic Collaboration Foundation, Seoul (KR)

(21) Appl. No.: 15/009,428

(22) Filed: Jan. 28, 2016

(30) Foreign Application Priority Data
May 22, 2015 (KR) 10-2015-0072190

(51) Int. Cl. A61C 19/06; H02M 7/44; H05H 1/24; A46B 15/00; A46B 9/04

(52) U.S. Cl. CPC A61C 19/06; A46B 15/00; A46B 9/04; H05H 1/2406; H02M 7/44; A46B 2200/1066; H05H 2001/2418

(57) ABSTRACT

A plasma toothbrush having an atmospheric plasma generator integrated with a toothbrush and the shape of a conventional toothbrush so that ordinary users operate the plasma toothbrush in a convenient and safe way for treating the teeth and oral cavity with plasma, for which the plasma toothbrush is equipped, in the lower end portion, with the plasma generator that employs dielectric barrier discharge, receives electric power using a domestic power source, rechargeable battery or disposable dry cell, includes an electrode plate to which high voltage is applied and a dielectric layer that covers the electrode plate and assumes the shape of a conventional toothbrush.

### CROSS-REFERENCE TO RELATED APPLICATIONS

This application claims the benefit of Korean application serial number 10-2015-0072190 filed on May 22, 2015, which is all hereby incorporated by reference in its entirety.

### BACKGROUND OF THE DISCLOSURE

1. Field of the Disclosure

The present disclosure relates to a toothbrush that generates plasma, and more particularly, to a plasma toothbrush that generates, during toothbrushing, plasma that takes effect upon teeth and oral cavity, thereby conveniently eliminating various bacteria, increasing the effect of toothbrushing by conveniently eliminating food-induced organic film that adheres to teeth and promoting teeth whitening.

2. Description of the Related Art

A plasma toothbrush refers to a toothbrush that is equipped with a plasma generator in order to obtain the effects of plasma including sterilization, oral cavity and gingiva cell activation and skin regeneration, strong oxidation that leads to decomposition of the organic matters that adhere to teeth, thereby teeth whitening, elimination of the bacteria that cause dental caries, etc.

Plasma is generated by, inter alia, atmospheric pressure plasma generation technology that employs, using high AC voltage, the dielectric barrier discharge method to discharge electricity with ease, the atmospheric pressure plasma generator of which has a simple configuration and is easy to operate, thereby seeing various applications in biological treatments because it doesn't require any independent electric discharge gas.

It may be required to have such an atmospheric pressure plasma generator supplied with, when applied to aesthetic and/or medical devices, a domestic power source and, particularly, a portable power source such as batteries at the same time.

A dielectric barrier discharge plasma generator includes metallic electrodes with a high electric conductivity to apply high AC voltage to that is coated with a dielectric layer that has a certain thickness while, when the dielectric layer applied to the electrodes contact with a tooth or gingival or oral mucosa, plasma is generated between the contact and electrode surface so that the contact area is treated by the plasma thus generated.

As described above, a plasma toothbrush generates plasma during toothbrushing although it may be used according to a method identical to that used for a typical toothbrush that is used with toothpaste.

Related art includes a plasma jet generator, as disclosed in Korean Patent Registration No. 10-1320291, that is used for dental applications but inappropriate for an ordinary user to manipulate, which is similar to an apparatus provided in Korean Patent Registration No. 10-1056097 and a gun-shaped plasma generator, as disclosed in Korean Patent Registration No. 10-1319453, that also has such drawbacks as portability and expertise.

### SUMMARY OF THE DISCLOSURE

The present disclosure is directed to a plasma toothbrush combining an atmospheric pressure plasma generator with a toothbrush, thereby assuming the shape of a conventional toothbrush so that ordinary users operate the plasma toothbrush in a convenient and safe way for treating their teeth and oral cavity with plasma.

In other words, the present disclosure provides a plasma toothbrush that is supplied with electric power using a domestic power source, rechargeable battery or disposable dry cell, thereby both the power supply and toothbrush being portable and assumes the shape of a conventional toothbrush so that it is used in the same way as a conventional toothbrush is used.

In particular, a toothbrush according to the present disclosure is safe in a thermal and/or electrical aspect, easy and simple to use and manufactured also in easy and simplified processes.

A toothbrush according to the present disclosure that includes an electrode plate to which high voltage is applied and a dielectric layer that coats the electrode plate is equipped, in the lower end of the toothbrush, with a dielectric barrier discharge plasma generator and supplied with electric power using an ordinary domestic power source, rechargeable battery or disposable dry cell, and assumes the shape of a conventional toothbrush.

The high voltage application electrode receives pulse power or a few kV of AC power the frequency of which ranges a few Hz to a few dozen of kHz and generates plasma when toothpaste foam and saliva are electrically grounded during toothbrushing.

In order to receive electric power, a plasma toothbrush is equipped, typically, with a DC/AC inverter in a power source connection to use an ordinary domestic power source that is 60 Hz, 110 or 210 V or portable dry cell that is DC 12 or 24 V, which renders the plasma toothbrush mobile.

A plasma toothbrush according to the present disclosure may include a main body having a toothbrush head in the anterior surface of which toothbrush strands are stuck and assuming the shape of a conventional toothbrush, a conductive plate electrode that is placed on the anterior surface of the toothbrush head and has holes through which the toothbrush strands extends frontwards from the anterior surface of the toothbrush, a dielectric layer made of an insulator that covers the electrode and a wire that is connected to, thereby applying voltage to, the electrode that has the holes and drawn out of the toothbrush-shaped main body, wherein plasma is generated between the electrode and oral mucosa, tooth whitener or toothpaste when voltage is applied to the electrode.

The plasma toothbrush may further include a loop- or mesh-shaped ground electrode that is placed on the dielectric layer and a ground wire that is connected to the ground electrode, wherein the ground electrode contacts, during toothbrushing with the plasma toothbrush, with oral mucosa, teeth or preparation, thereby being electrically grounded while plasma is generated between the electrode and ground electrode and ground surface when voltage is applied to the electrode.

A plasma toothbrush that may be manufactured more easily is provided according to another exemplary aspect of the present disclosure by placing a covered wire and ground wire in the bottom surface, in which toothbrush strands are stuck, of the toothbrush, thereby generating plasma between the covered wire and ground wire that are placed in the bottom surface of the toothbrush head of the toothbrush anterior surface.

The covered wire and ground wire may be configured in various ways. For example, a plasma toothbrush according to the present disclosure may include a main body having a toothbrush head in the anterior surface of which toothbrush strands are stuck and a covered wire electrode that coils along the clearance between the toothbrush strand bundles in the toothbrush head and runs across and alongside the toothbrush head, wherein the wire electrode, as a covered wire that has a conductor wire core coated with an insulating dielectric layer, is drawn out of the toothbrush-shaped main body and connected to a power source then supplied with electric power, thereby generating plasma.

The plasma toothbrush may further include a conductor ground wire that is placed on the wire electrode, wherein the ground electrode contacts, during toothbrushing with the plasma toothbrush, with oral mucosa, teeth or preparation, thereby being electrically grounded while plasma is generated between the electrode and ground electrode and ground surface when voltage is applied to the electrode.

According to still another exemplary aspect of the present disclosure, both the covered wire and the ground wire are placed on the same bottom plane of the toothbrush anterior surface, thereby generating plasma in the proximity of the covered wire and the ground wire.

Meanwhile, the plasma toothbrush provided by the present disclosure may employ pulse or AC power as the power source and have a DC/AC inverter in the end of the wire that is to be connected to the power source so that any one of domestic power source, rechargeable battery and disposable dry cell is selected to generate plasma.

The plasma toothbrush according to the present disclosure is capable of treating the teeth and oral cavity using plasma it generates, thereby preventing dental diseases and preserving the teeth bright and healthy so that a user keeps the gingivae and oral cavity healthy and uses it conveniently like a conventional tooth brush although the plasma toothbrush has the shape and configuration of a conventional toothbrush and is used in the same way as conventional toothbrushing.

Moreover, the plasma toothbrush according to the present disclosure remains electrically safe during toothbrushing because toothpaste, foam, saliva, teeth and gingivae and oral mucosa are kept electrically grounded and may increase the effect of toothpaste-based toothbrushing because toothpaste foam and various species of excited plasma particles take effect on the teeth and gingival and oral mucosa.

In addition, the plasma toothbrush according to the present disclosure that is convenient to use as described above is also capable of being manufactured very easily.

The plasma generator according to the present disclosure may add to portability because it is equipped with a DC/AC inverter, thereby being supplied with electric power via a domestic power source, rechargeable battery or disposable dry cell.

Moreover, the plasma toothbrush according to the present disclosure may provide electrical and thermal safety.

### BRIEF DESCRIPTION OF THE SEVERAL VIEWS OF THE DRAWING

FIGS. 1A-10 show top, side cross-sectional and bottom views a conventional toothbrush.

FIGS. 2A, 2B and 2C show top, side cross-sectional and bottom views of a plasma toothbrush, respectively, according to a first embodiment of the present disclosure.

FIGS. 3A and 3B shows an electrode layout of a plasma toothbrush according to a second embodiment of the present disclosure.

FIGS. 4A-4C illustrate an electrode layout of a plasma toothbrush according to a third embodiment of the present disclosure.

FIG. 5 illustrates an electrode layout of a plasma toothbrush according to a fourth embodiment of the present disclosure.

FIGS. 6A and 6B illustrate an electrode layout of a plasma toothbrush according to a fifth embodiment of the present disclosure.

FIGS. 7A-7B illustrate an electrode layout of a plasma toothbrush according to a sixth embodiment of the present disclosure.

FIG. 8 illustrates a plasma toothbrush system equipped with a portable power source box according to one embodiment of the present disclosure.

FIG. 9 shows a perspective view of a plasma toothbrush system according to one embodiment of the present disclosure.

### DETAILED DESCRIPTION OF THE EMBODIMENTS

Embodiments of a plasma toothbrush according to the present disclosure is described below in detail with reference to the drawings.

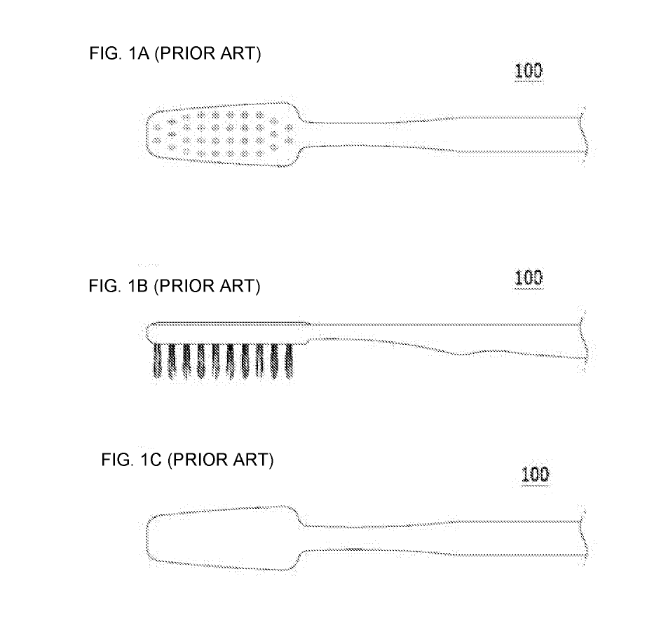

A conventional toothbrush is illustrated in FIGS. 1A-10 whereas the present disclosure provides a plasma toothbrush that assumes the shape of such a conventional toothbrush but is equipped with an electrode on the anterior surface in which toothbrush strands are stuck, thereby generating plasma in the proximity of the bottom surface.

The embodiments of the present disclosure present a configuration in which a plasma generator is installed to a conventional toothbrush as illustrated in FIGS. 1A-10. A conventional toothbrush has a toothbrush head the dimension of which is about 10 mm×30 mm. Fine strands are bundled up into a plurality of bundles and stuck in the bottom surface, where a bundle of such strands has a diameter of about 1 to 1.5 mm. Such bundles add up to 43 configuring a longitudinal and latitudinal matrix arrangement as illustrated in FIG. 1A. The present disclosure provides a plasma toothbrush that generates plasma using such a conventional toothbrush.

The present disclosure installs an electrode to a conventional toothbrush and operates the toothbrush thus configured by electric power, thereby generating plasma and is assorted as per operating method determined by the arrangement and polarity of the electrode and power source. The electrode is made of thin metallic film or typical covered or bare wire. Based on operating method, the present disclosure is assorted into 2-electrode type that generates plasma between a voltage application electrode and a ground electrode and 3-electrode type that generates plasma between those three electrodes that include two voltage application electrodes each of which has a polarity different from each other and a ground electrode while, based on power source, the present disclosure is assorted into domestic power source type that connects the plasma toothbrush to a typical household power outlet and battery type that uses a rechargeable battery.

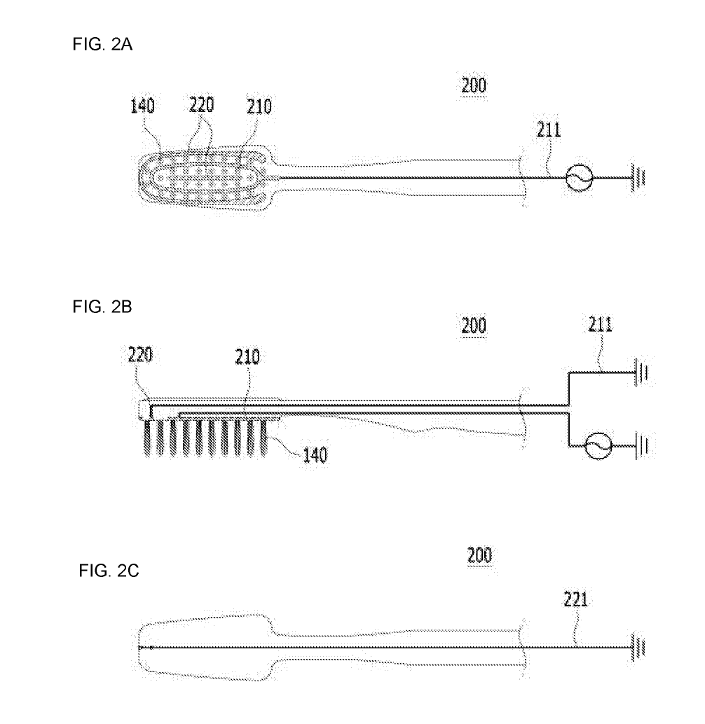

As discussed below in conjunction with FIGS. 2A-2C, the electrode according to the present disclosure that is arranged on the toothbrush head bottom surface in which toothbrush strands 140 are stuck includes a voltage application electrode 210 to which high voltage is applied and a ground electrode 220 both of which are manufactured out of a conductive metallic plate or typical conductive wire. It may be required that the conductive metallic wire have a thickness of 1 mm or less and the conductive wire have a diameter of 0.5 mm or less. The voltage application electrode 210 should be coated with an insulator. More specifically, the voltage application electrode 210 is fabricated out of thin metallic plate then coated with an insulating material across the entire surface while, when using an electric wire for the electrode, a covered wire on which a dielectric material has been applied, where it may be required that the metallic plate thus coated have a thickness of 2 mm or less while the covered wire have a diameter of 1 mm or less. Meanwhile, although it is possible to have the ground electrode 220 either covered or bare, it may be required to use a bare metallic matter or bare electric wire for the ground electrode in order to lower the discharge voltage, thereby increasing related electrical safety. The material of the bare metallic matter or electric wire for the ground electrode is typically selected from copper and its alloys and stainless steel that is corrosion resistant and may further include gold, silver, platinum, etc.

Those embodiments described below are assorted as per power source connection method determined by the arrangement and operation of the voltage application electrode 210 and the ground electrode 220.

FIGS. 2A, 2B and 2C is a top view, cross-sectional view and bottom view, respectively, of a plasma toothbrush 200 according to a first embodiment, where the voltage application electrode 210 and the ground electrode 220 are arranged on an identical plane, of the present disclosure to describe the electrode layout.

FIG. 2A is a top view of the anterior portion of a toothbrush that has the toothbrush strands 140, where the electrodes are arranged on an identical plane of the toothbrush anterior portion bottom surface in which the toothbrush strands 140 are stuck. The voltage application electrode 210 made of a metallic plate is, as illustrated in FIG. 2A, elliptical running track-shaped and has an opening in the central area while the ground electrode 220 is rectangular channel-shaped and surrounding the elliptical running track-shaped voltage application electrode 210 on the one hand and long island-shaped and arranged longitudinally across the central area of the elliptical running track-shaped voltage application electrode 210 on the other hand, both of which are installed on the bottom surface that has no toothbrush strands 140, thereby generating plasma between the voltage application electrode and the ground electrode, which renders plasma generated on the bottom surface of the toothbrush in which the toothbrush strands are stuck.

It may be required that the wire of the voltage application electrode 210 and the ground electrode 220 have a diameter of 1 mm or less so that the toothbrush strands are arranged on the bottom plane between the electrodes.

The voltage application electrode 210 is, as illustrated in FIG. 2B, a side view of the toothbrush, is connected to a voltage application electrode lead wire 211 that is buried inside the toothbrush head in the lower portion in proximity of the anterior surface, thereby being connected to a power source while the ground electrode 220 is connected to a ground lead wire 221 that is buried upright near the tip portion of the toothbrush head, thereby being grounded.

The ground lead wire 221 is illustrated in FIG. 2C, a bottom view of the toothbrush head, where the voltage application electrode lead wire 211 and the ground lead wire 221 are placed with a clearance in between to prevent a short circuit.

A plasma discharge is generated between the ground electrode 220 and the voltage application electrode 210, as illustrated in FIG. 2, in proximity of the toothbrush head 140, thereby performing plasma treatments during brushing the teeth and/or gingivae with the toothbrush strands, where the ground electrode 220 is contact with the preparation, etc. such as toothpaste, etc. in the oral cavity during toothbrushing, thereby being grounded and remaining at 0 V, thereby generating plasma between the voltage application electrode 210 the ground surface in the oral cavity, which may promote the effect of the preparation such as toothpaste and, with the help of toothbrushing, removal of plague, etc. and whitening performed by those various radicals produced by the plasma discharge.

The plasma toothbrush 200 that has such a configuration described above assumed the shape of a conventional toothbrush 100, thereby helping a user be convenient just as a conventional toothbrush and being manufactured with ease.

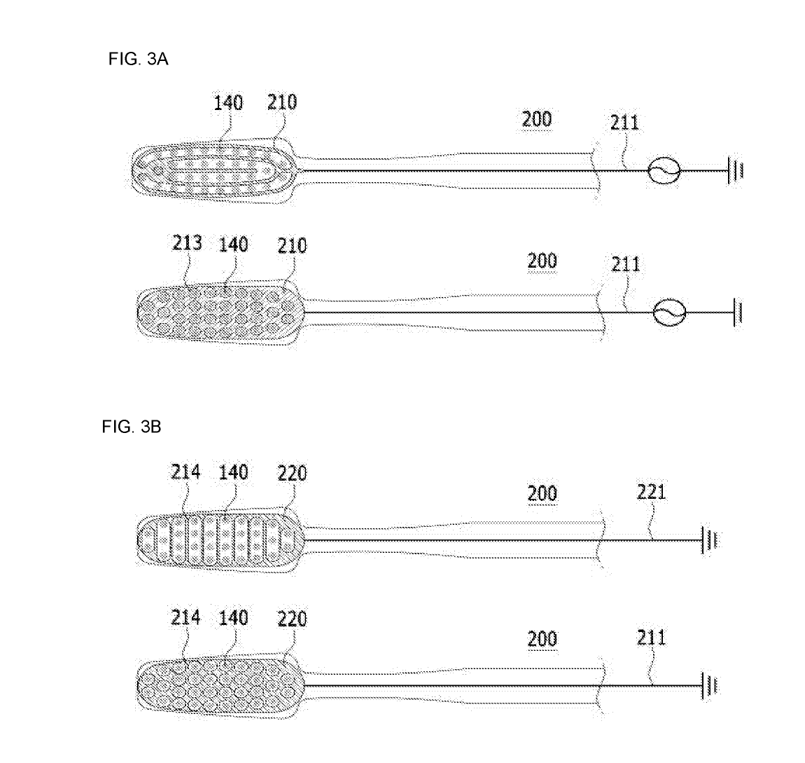

FIGS. 3A and 3B are cross-sectional views of the electrodes that are arranged on the toothbrush bottom surface, in which the toothbrush strands are stuck, of the plasma toothbrush 200 according to a second embodiment of the present disclosure, wherein the ground electrode 220 is placed over the voltage application electrode 210 that is placed in the lower portion of the toothbrush bottom plane in which the toothbrush strands are stuck, which makes a double-layer electrode.

FIG. 3A includes a cross-sectional view of the voltage application electrode 210 that shows a plurality of toothbrush strand holes 213 through which the toothbrush strands 140 are stuck, where it may be required each of the toothbrush strand holes 213 have a diameter of 1.5 mm or more considering a bundle of the toothbrush stands has a diameter about 1.5 mm.

The voltage application electrode 210 may have another geometry according to another aspect of the present disclosure.

For example, the voltage application electrode 210 has a slit 215 opening where there are the toothbrush strands 140 inside the slit, wherein it may be required the slit 215 is arranged in the longitudinal direction of the toothbrush head.

FIG. 3B illustrates the shape of the ground electrode, where different toothbrush strand holes 214 that correspond to the toothbrush strand holes 213 or the voltage application electrode 210 that is place beneath and have a diameter larger than that of the toothbrush strand holes 213 in order to expose the toothbrush strands 140.

Therefore, when the ground electrode 220 covers the voltage application electrode 210, the toothbrush strand holes 214 of the ground electrode 220 may be required to have a diameter of 2 mm or more so that it is larger than the diameter of the toothbrush strand holes 213 of the voltage application electrode 210.

The ground electrode 220 in which a plurality of the toothbrush strand holes 214 is placed over the voltage application electrode 210 in which the toothbrush strand holes 213 or slit.

When the voltage application electrode 210 has the slits arranged longitudinally across the toothbrush head, the ground electrode 220 may be placed latitudinally across the toothbrush head cutting across the slits, thereby opening the slits, so that the toothbrush strands 140 are exposed.

The voltage application electrode lead wire and the ground electrode lead wire are drawn in a way similar to that illustrated in FIGS. 2B and 2C.

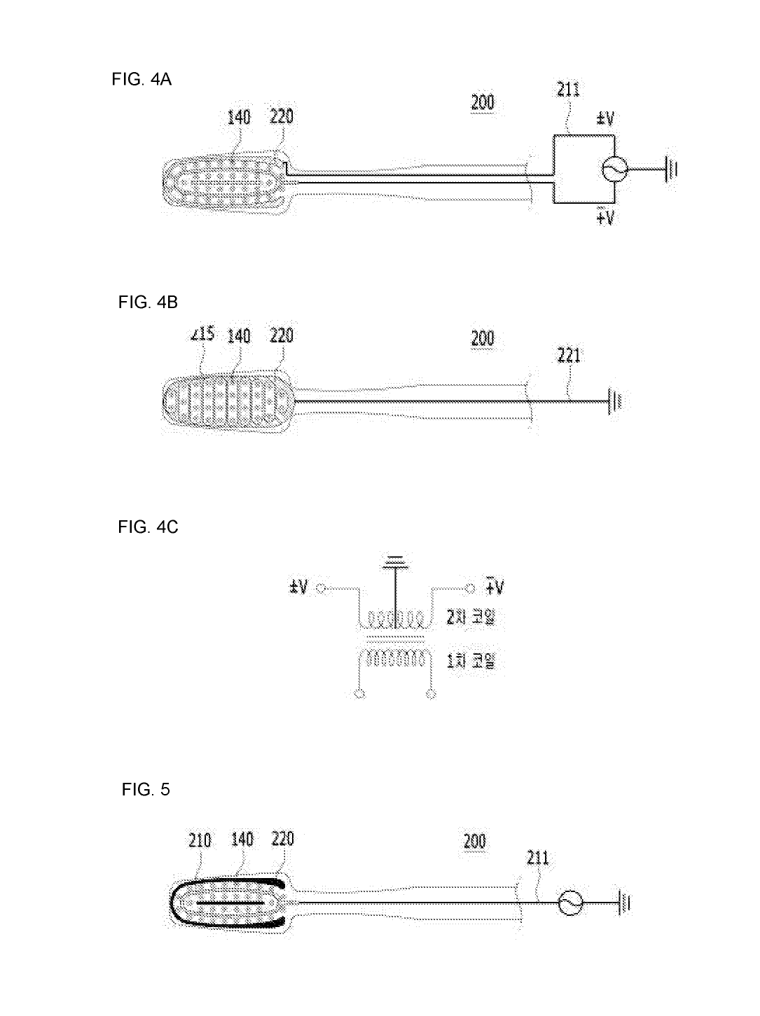

FIGS. 4A and 4B are top views of the voltage application electrode 210 arranged on the bottom surface, in which the toothbrush strands are stuck, of the plasma toothbrush 200 according to a third embodiment, where FIGS. 4A-4B show a 3-electrode configuration that includes two voltage application electrodes and one ground electrode, while FIGS. 2A-3B show a 2-electrode configuration that include a single voltage application electrode and a single ground electrode.

More specifically, in the 3-electrode configuration, each of the voltage application electrodes has a polarity of voltage different from each other, or +V to one electrode and −V to the other, and vice versa, where the two voltage application electrodes 210 are placed in the lower portion of the bottom plane in which the toothbrush strands are stuck and the ground electrode 220 covers over the voltage application electrodes, which makes a double-layer electrode, and where the two voltage application electrodes 210 are arranged in the same way as illustrated in FIG. 2A whereas one of the electrodes that are placed as the ground electrode in FIG. 2A also becomes the voltage application electrode 210 over which the ground electrode 220 is placed as illustrated in FIG. 3B.

In other words, a rectangular channel-shaped electrode that is placed along the edge side of the toothbrush head bottom plane and a long island-shaped electrode in the center are integrated into the single voltage application electrode 210 to which +V is applied while a running track-shaped electrode placed between the rectangular channel-shaped electrode and long island-shape electrode is employed as the voltage application electrode 210 to which −V is applied as illustrated in FIG. 4A, where the polarity can be exchangeable because each of the electrodes only has to have a polarity different form each other and the ground electrode 220 is placed over the two voltage application electrodes as illustrated in FIG. 4B.

FIG. 4C shows a transformer of an inverter to describe a method for applying high voltage the polarity of which is shifted, where the secondary coil of the transformer is grounded in the center, thereby applying voltage to either end of the coil the polarity of which is different from each other.

According to yet another aspect of the present disclosure, as a method for applying voltage the polarity of which is different to each other, two transformers are connected in series and the secondary coil of each of the transformers is grounded in the center, thereby applying voltage to either end of each of the two transformers the polarity of which is different to each other.

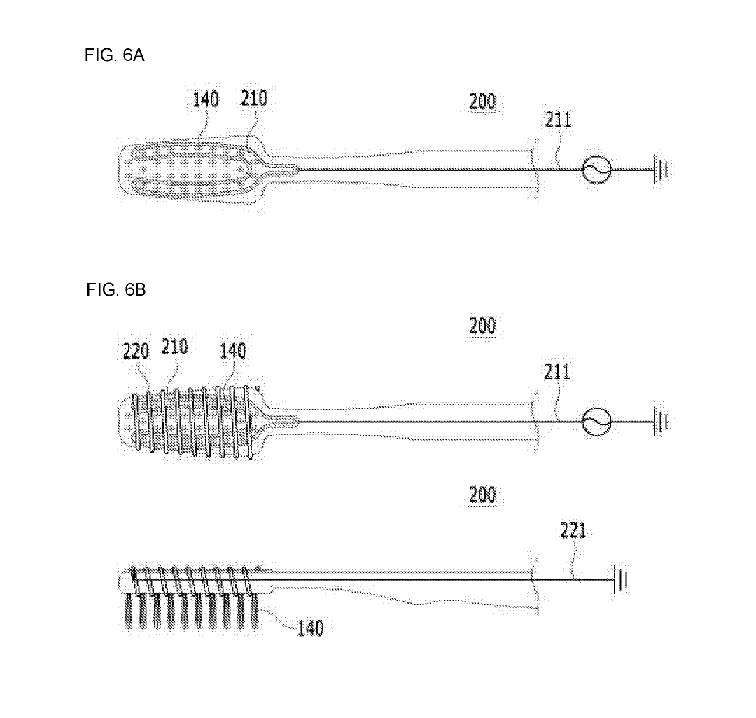

FIG. 5 and FIGS. 6A-6B illustrate a fourth and fifth embodiment of the present disclosure, respectively, where a covered wire is selected as the voltage application electrode while a bare wire as the ground electrode.

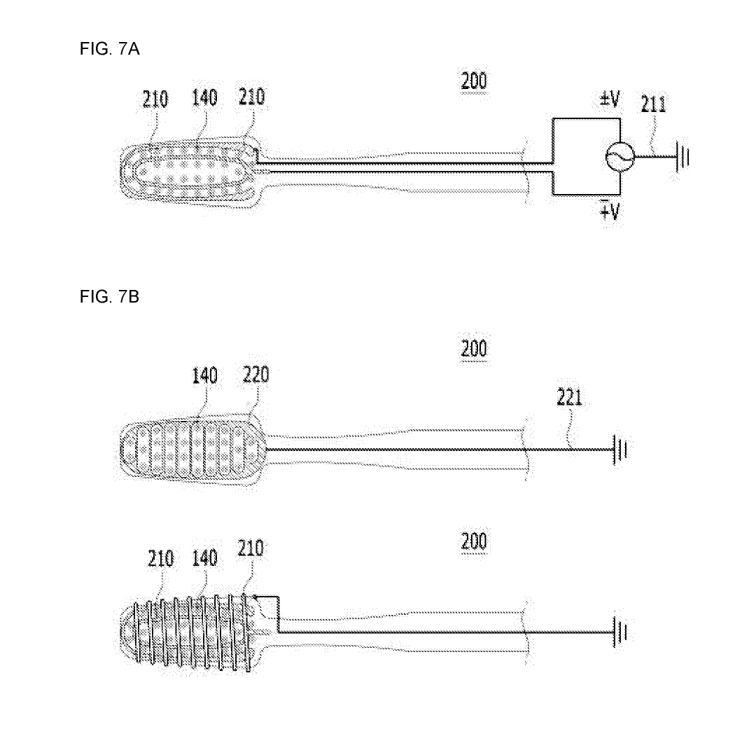

FIG. 7 is illustrates a sixth embodiment that is a 3-electrode configuration of the present disclosure, where a covered wire is employed as the voltage application electrode while a metallic plate is fabricated for the ground electrode.

FIG. 5 illustrates a fourth embodiment of the present disclosure that replaces the electrodes of the first embodiment as illustrated in FIG. 2A with a covered wire and typical conductive wire, where the ground electrode 220 that is a typical conductive, or bare, wire is half-buried, so that about a half of the wire is buried, along the edge side and in the central area of the bottom plane in which the toothbrush strands are stuck while the voltage application electrode 210 that is a covered wire assumes the shape of a running track and is placed between the ground electrodes 220, the lead wires of which are drawn by the method of FIGS. 2B and 2C.

FIGS. 6A-6B illustrate a fifth embodiment of the present disclosure that refers to a voltage application electrode configuration similar to that illustrated in FIG. 3A, where the voltage application electrode 210 that is made of a covered wire is half-buried in the toothbrush head bottom plane to have a rectangular channel shape as illustrated in FIG. 6A, over which the ground electrode 220 made of a bare wire coils around the toothbrush head away from the toothbrush strands in order to expose the toothbrush strands 140 as illustrated in FIG. 6B.

FIGS. 7A and 7B, according to a sixth embodiment of the present disclosure, show a 3-electrode configuration, where two of the voltage application electrode 210 are placed on the bottom plane in which the toothbrush strands 140 are stuck along the edge and in the central area, respectively, as illustrated in FIG. 7A, to either side of which voltage is applied the polarity of which is different from each other, or +V and −V or −V and +V.

The ground electrode 220 of FIG. 7B that is fabricate to have a plurality of hole in a metallic plate as illustrated in FIG. 3B is placed over the voltage application electrode 210.

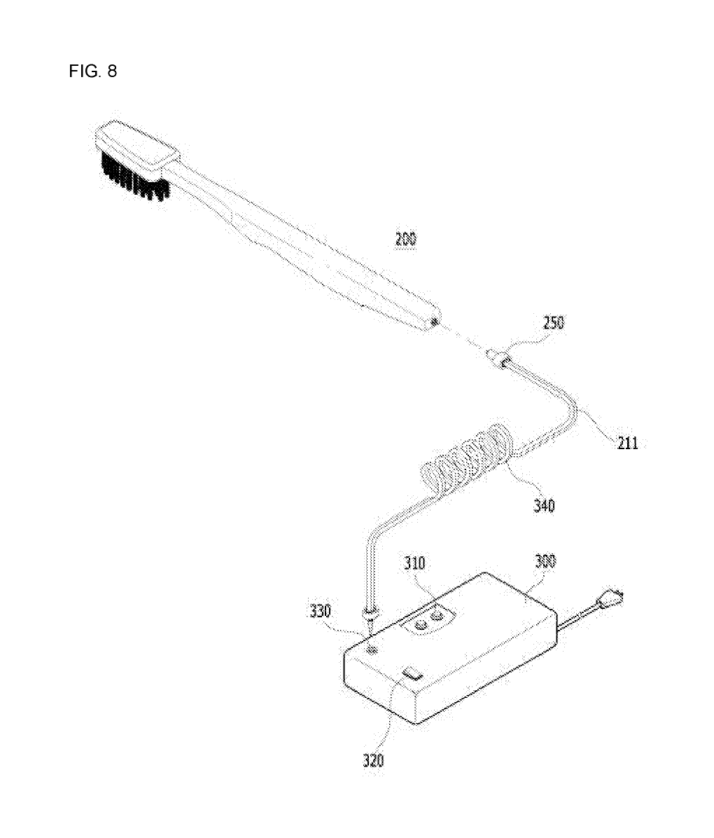

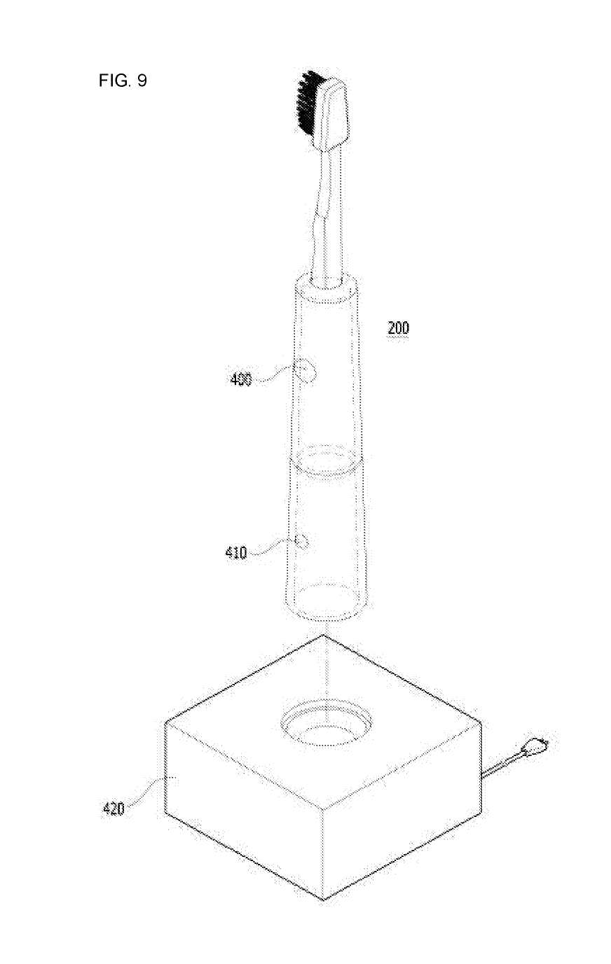

FIGS. 8 and 9 show the entire plasma toothbrush systems whereas FIG. 2A through FIG. 7B illustrate a convenient edition with portability of the plasma toothbrush.

FIG. 8 illustrates a plasma toothbrush system equipped with a portable power source box, illustrated only in FIG. 4 but equipped also for the plasma toothbrush 100 of FIG. 1, which has an inverter to supply high voltage to generate plasma and is to be plugged in a household power outlet.

The power source box has terminals 310 to which the end of the wire for the plasma generating electrodes 110, 210 is connected and a D/A inverter in the inside that supply high voltage required for generating plasma, where an adjustment knob 330 may be required to be provided to adjust the inverter voltage in the power source box 300, and an ON/OFF switch 320 may be as well.

Meanwhile, the 2-electrode type plasma toothbrush is connected to the power source box via a 2-polarity power cable as illustrated in FIGS. 2, 3, 5 and 6 while the plasma toothbrush of FIGS. 4 and 7 is connected to the power source box via a 3-polarity power cable.

The quantity of plasma thus generated is determined by adjusting the voltage applied to the voltage application electrodes 110, 210, where the plasma quantity is appropriate when a user doesn't notice the generation of plasma.

The high voltage application electrode of the plasma toothbrush receives pulse power or a few kV of AC power the frequency of which ranges a few Hz to a few dozen of kHz and generates plasma when toothpaste foam and saliva are electrically grounded during toothbrushing, where the current that flows by plasma generation is adjusted finely down to 1 or 2 mA, thereby producing only a few watts of power consumption, which describes the electrical safety of the plasma toothbrush provided by the present disclosure.

In order to receive electric power, a plasma toothbrush is equipped, typically, with a DC/AC inverter in a power source connection to use an ordinary domestic power source that is 60 Hz, 110 or 210 V or portable dry cell that is DC 12 or 24 V, which renders the plasma toothbrush mobile.

FIG. 9 is an outline view of the plasma toothbrush system that uses a rechargeable, or secondary, battery, where the plasma toothbrush has in the inside a DC/AC converter 400 and a secondary battery that supplies the inverter with DC voltage that ranges from 12 to 24 V. The plasma toothbrush is mounted to a charger 420 to be recharged when the battery 410 is discharged.

As described thus far, the plasma toothbrush provided by the present disclosure provides is easy to manufacture and use as well.

The present disclosure should not be construed as being limited to the embodiments set forth herein but be defined by the Claims, and will be embodied in many different forms within the scope of the Claims by those skilled in the art.

### REFERENCE CHARACTERS

100: Toothbrush
200: Plasma toothbrush
210: Voltage application electrode
211: Voltage application electrode lead wire
213, 214: Toothbrush strand holes
215: Slit
220: Ground electrode
221: Ground electrode lead wire
230: Toothbrush strands
300: Power source box
310: Terminal
320: ON/OFF switch
330: Adjustment knob
340: Power cable
400: DC/AC inverter
410: Battery
420: Charger

What is claimed is:

1. A plasma toothbrush, comprising:
a main body that is toothbrush-shaped and has a toothbrush head in which toothbrush strands are stuck in the anterior plane of the toothbrush head;
a voltage application electrode that is arranged between the toothbrush strands stuck in the toothbrush head bottom plane; and
a ground electrode that is arranged between the toothbrush stands in the proximity of and with a clearance from the voltage application electrode,
wherein the voltage application electrode is made of a conductive material and covered with a dielectric material, the ground electrode is made of a conductive material, the ground electrode is grounded, and the voltage application electrode is connected to a power source to be supplied with electric power, thereby generating plasma.

2. The plasma toothbrush of claim 1, wherein the voltage application electrode and the ground electrode are arranged on the toothbrush head bottom plane, the voltage application electrode is formed to have the shape of a running track, and the ground electrode is arranged in- and outside of the voltage application electrode that has the shape of a running track so that the ground electrode inside the track is stick-shaped and the ground electrode outside the track is placed along the edge side of the track.

3. The plasma toothbrush of claim 2, wherein the voltage application electrode is made of a covered wire.

4. A plasma toothbrush, comprising:
a main body that is toothbrush-shaped and has a toothbrush head in which toothbrush strands are stuck in the anterior plane of the toothbrush head;
a voltage application electrode having an opening so that the toothbrush strands stuck in the toothbrush head bottom plane are exposed; and
a ground electrode that is placed over the voltage application electrode and has an opening so that the toothbrush strands are exposed,
wherein the voltage application electrode is made of a conductive material and covered with a dielectric material, the ground electrode is made of a conductive material, the ground electrode is grounded, and the voltage application electrode is connected to a power source to be supplied with electric power, thereby generating plasma.

5. The plasma toothbrush of claim 4, wherein the voltage application electrode includes an opening that is a plurality of holes formed in a metallic plate, and the ground electrode has an opening that is a plurality of holes formed in a metallic plate, the hole of which has a diameter that is larger than that of the hole formed in the voltage application electrode.

6. The plasma toothbrush of claim 4, wherein the voltage application electrode has an opening that is a plurality of slits formed in a metallic plate, being aligned in the latitudinal or longitudinal direction along the toothbrush head bottom plane so that the toothbrush strands are exposed; and the ground electrode includes an opening that is a plurality of holes or slits formed in a metallic plate, wherein, when the opening is the holes, the holes are formed where the toothbrush strands are stuck while, when the opening is the slits, the slits are aligned orthogonally to the alignment of the slits formed in the voltage application electrode so that the slits formed in the voltage application electrode cut across the slits formed in the ground electrode.

7. A plasma toothbrush, comprising:
a main body that is toothbrush-shaped and has a toothbrush head in which toothbrush strands are stuck in the anterior plane of the toothbrush head;
a voltage application electrode having an opening so that the toothbrush strands stuck in the toothbrush head bottom plane are exposed; and
a ground electrode that is placed over the voltage application electrode, being a conductive wire and coiling around the toothbrush head away from the toothbrush strands,
wherein the voltage application electrode is made of a conductive material and covered with a dielectric material, the ground electrode is made of a conductive material, the ground electrode is grounded, and the voltage application electrode is connected to a power source to be supplied with electric power, thereby generating plasma.

8. A plasma toothbrush, comprising:
a main body that is toothbrush-shaped and has a toothbrush head in which toothbrush strands are stuck in the anterior plane of the toothbrush head;
a voltage application electrode that is arranged between the toothbrush strands; and
a ground electrode that is placed over the voltage application electrode, being a conductive wire and coiling around the toothbrush head away from the toothbrush strands,
wherein the voltage application electrode is made of a conductive material and covered with a dielectric material, the ground electrode is made of a conductive material, the ground electrode is grounded, and the voltage application electrode is connected to a power source having two electrode tracks, each of which is electrically separated from each other to which voltage with a different polarity is applied in order to form a 3-electrode configuration, thereby generating plasma.

9. A power source box that supplies the plasma toothbrush of claims 1 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

10. A power source box that supplies the plasma toothbrush of claims 4 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

11. A power source box that supplies the plasma toothbrush of claims 7 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

12. A power source box that supplies the plasma toothbrush of claims 8 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

13. A power source box that supplies the plasma toothbrush of claims 2 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

14. A power source box that supplies the plasma toothbrush of claims 5 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.

15. A power source box that supplies the plasma toothbrush of claims 6 with electric power comprising:
a DC/AC inverter;
an adjustment knob that adjusts the inverter power; and
a power source connection to which the electrode of the plasma toothbrush is connected via an electric wire, thereby generating plasma at the electrode of the plasma toothbrush using any one of domestic power source, rechargeable battery or disposable dry cell.
